(19) United States
(12) Patent Application Publication
(10) Pub. No.: US 2011/0098080 A1
(43) Pub. Date: Apr. 28, 2011

(54) DUAL MODE COMMUNICATION DEVICE

(75) Inventor: CHIA-HAO KUO, Tu-Cheng (TW)

(73) Assignee: HON HAI PRECISION INDUSTRY CO., LTD., Tu-Cheng (TW)

(21) Appl. No.: 12/649,484

(22) Filed: Dec. 30, 2009

(30) Foreign Application Priority Data
Oct. 26, 2009 (CN) 200910308789.6

(51) Int. Cl. H04M 1/00

(52) U.S. Cl. 455/552.1

(57) ABSTRACT

A dual-mode communication module detects a generic access network (GAN) signal generated by a GAN and communicates with the GAN. The dual-mode communication module measures quality of the GAN signal and enables either a GSM communication module or a GAN communication module of the device according to the quality of the GAN signal.

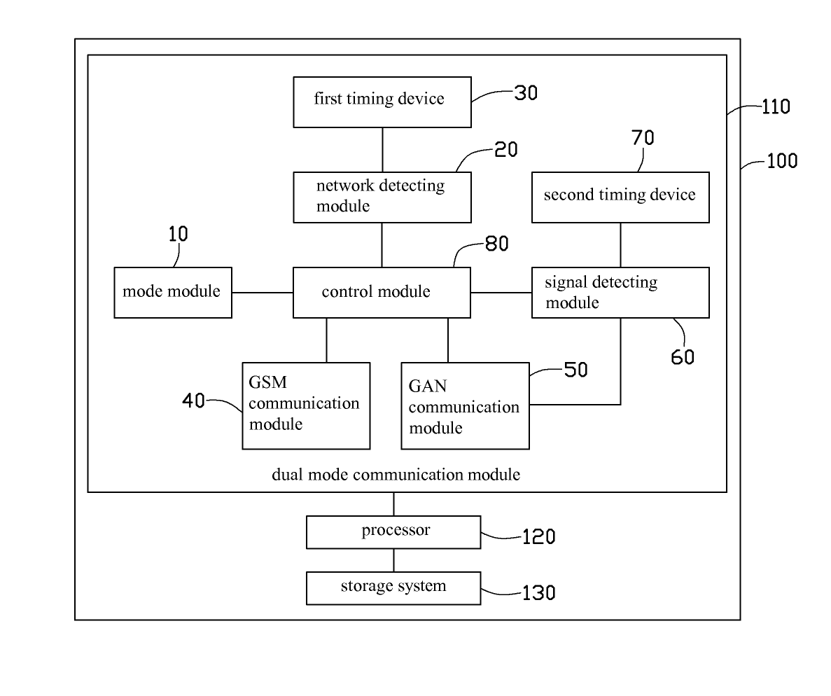

### BACKGROUND

1. Technical Field

The present disclosure relates to dual mode communication, and particularly, to a dual mode communication device which can selectively connect to a global system for mobile communications (GSM) network and a generic access network (GAN).

2. Description of Related Art

Single mode communication devices are gradually being replaced by dual-mode devices. Although the dual mode communication devices provide selective connection to GSM networks and GAN, the device's continuous detection of both networks at the same time significantly promotes battery drain of the device.

Therefore, a dual mode communication device which can overcome the above-described problems is desirable.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a schematic view of a dual mode communication device in accordance with an exemplary embodiment.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

Referring to the FIGURE, a dual mode communication device 100, according to an exemplary embodiment, is capable of communicating with a global system for mobile communications (GSM) network and a generic access network (GAN). The dual mode communication device 100 includes a dual mode communication module 110, a processor 120, and a storage system 130. One or more computerized codes of the dual mode communication module 110 may be stored in the storage system 130 and be executed by the processor 120.

The dual mode communication module 110 includes a mode module 10, a network detecting module 20, a first timing device 30, a GSM communication module 40, a GAN communication module 50, a signal detecting module 60, a second timing device 70, and a control module 80.

The mode module 10 is configured for switching the dual-mode communication device 100 between a standby mode and a communication mode. Normally, the dual mode communication device 100 remains in the standby mode. However, when a communication is needed or started, the mode module 10 is switched to the communication mode and generates a mode control signal to the control module 80.

The network detecting module 20 is configured for detecting a GAN signal during a first predetermined time, and generates a first network control signal if the GAN signal is available and a second network control signal if the GAN signal is not available.

The first timing device 30 connects with the network detecting module 20, configured for setting the first predetermined time.

The GSM communication module 40 is configured for communicating with the GSM network. The GSM network can operate in several frequency bands, such as 900 Hz band, 1800 Hz band, and 1900 Hz band.

The GAN communication module 50 is configured for communicating with GAN. The GAN is a wireless network, such as wireless broadband, BLUETOOTH, or WIFI. The frequency in which the GAN operates is different from that of the GSM network, and the range of the GSM network covers that of the GAN.

The signal detecting module 60 connects with the GAN communication module 50, and acquires the GAN signal, if any, from GAN communication module 50. The signal detecting module 60 measures quality (i.e., stability) of the GAN signal during a second predetermined time, and compares it with a pre-stored quality value and generates a first switching signal if the measured quality exceeds the pre-stored quality value and a second switching signal if the measured quality is lower than the pre-stored quality value and a second switching signal.

The second timing device 70 connects with the signal detecting module 20, configured for setting the second predetermined time.

The control module 80 connects with the mode module 10, the network detecting module 20, the GSM communication module 40, the GAN communication module 50, and the signal detecting module 60. The control module 80 is configured for enabling the GSM communication module 40 if receiving the second network control signal or the second switching signal, enabling the GAN communication module 50 if receiving the first network control signal or receiving the mode control signal and the first switching signal simultaneously.

In operation, the dual-mode communication device 100 may be in the standby mode initially. The network detecting module 20 detects the GAN signal in the first predetermined time. If GAN signal is detected, the network detecting module 20 generates the first network control signal which is transmitted to the control module 80. The control module 80 enables the GAN communication module 50 and keeps the GSM communication module 40 idle according to the first network control signal. If GAN signal is not detected, the network detecting module 20 generates the second network control signal which is transmitted to the control module 80. The control module 80 enables the GSM communication module 40 and keeps the GAM communication module 50 idle according to the second network control signal. After the dual-mode communication device 100 enables the GSM communication module 40 or the GAM communication module 50, the network detecting module 20 continues detecting the GAN signal, and signals the control module 80 to switch the dual mode communication device 100 to enable between the GSM communication module 40 and the GAM communication module 50.

When the dual-mode communication device 100 communicates with the GSM communication module 40, the network detecting module 20 continues detecting the GAN signal in the first predetermined time. If a GAN signal is detected by the network detecting module 20, the network detecting module 20 generates the first network control signal which is transmitted to the control module 80. The control module 80 enables the GAN communication module 50 and keeps the GSM communication module 40 idle. The dual-mode communication device 100 is exchanged to communicate with the GAN communication module 50.

When the dual-mode communication device 100 communicates with the GAN communication module 50, the signal detecting module 60 acquires the GAN signal from GAN communication module 50 in the second predetermined time. The signal detecting module 60 measures quality of the GAN signal, and compares the quality with the pre-stored quality value. If the quality of the GAN signal exceeds the pre-stored quality value, the signal detecting module 60 generates a first switching control signal which is transmitted to the control module 80, and the dual mode communication device 100 continues communicating with the GAN communication module 50. If the quality of the GAN signal is lower than the pre-stored quality value, the signal detecting module 60 generates a first switching control signal which is transmitted to the control module 80, and the dual-mode communication device 100 is exchanged to communicate with the GSM communication module 40.

If the communication is ended, the dual mode communication device returns to standby mode.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A dual-mode communication module, comprising:
a network detecting module configured for detecting a generic access network (GAN) signal generated by a GAN;
a GAN communication module configured for communicating with the GAN;
a global system for mobile communications (GSM) communication module configured for communicating with a GSM network;
a signal detecting module connected with the GAN communication module, and configured for measuring quality of the GAN signal;
a control module configured for enabling the GSM communication module or the GAN communication module; and
wherein, if the GAN signal is detected by the network detecting module, the control module enables the GAN communication module; when communicating with the GAN communication module, the signal detecting module compares the quality of the GAN signal with a pre-stored quality value; and if the quality of the GAN signal exceeds the pre-stored quality value, the control module continues to enable the GAN communication module.

2. The dual-mode communication module in claim 1, wherein if the quality of the GAN signal is lower than the pre-stored signal quality, the control module enables the GSM communication module and keeps the GAN communication module idle.

3. The dual-mode communication module in claim 2, when the control module enables the GSM communication module, the network detecting module continues detecting the GAN signal.

4. The dual-mode communication module in claim 1, if the GAN signal is not detected by the network detecting module, the control module enables the GSM communication module and remains the GAN communication module idle.

5. The dual-mode communication module in claim 4, when the control module enables the GSM communication module, the network detecting module continues detecting the GAN signal.

6. The dual-mode communication module in claim 1, further comprising a mode module connected with the control module, the mode module configured for switching the dual mode communication device between a standby mode and a communication mode.

7. The dual-mode communication module in claim 1, further comprising a first timing device connected with the network detecting module, wherein the network detecting module detects the GAN signal in the first predetermined time of the first timing device.

8. The dual-mode communication module in claim 1, further comprising a second timing device connected with the signal detecting module, the signal detecting module acquiring the GAN signal from GAN communication module in the second predetermined time of the second timing device.

9. The dual-mode communication module in claim 1, wherein the range of the GAN is covered by that of the GSM network.

10. A dual-mode communication device, comprising:
a dual-mode communication module comprising:
a network detecting module configured for detecting a generic access network (GAN) signal generated by a GAN;
a GAN communication module configured for communicating with a GAN;
a global system for mobile communications (GSM) communication module configured for communicating with a GSM network;
a signal detecting module connected with the GAN communication module, and configured for measuring quality of the GAN signal;
a control module configured for enabling the GSM communication module or the GAN communication module; and
wherein, if the GAN signal is detected by the network detecting module, the control module enables the GAN communication module; when communicating with the GAN communication module, the signal detecting module compares the quality of the GAN signal with a pre-stored quality value; and if the quality of the GAN signal exceeds the pre-stored quality value, the control module continues to enable the GAN communication module;
a storage system configured to store one or more computerized codes of the dual mode communication module; and
a processor configured to execute the computerized codes stored in the storage system.
